(19) United States
(12) Patent Application Publication
(10) Pub. No.: US 2004/0208516 A1
(43) Pub. Date: Oct. 21, 2004

(54) Systems and methods for launch power pre-emphasis

(76) Inventors: Thomas Clark, Columbia, MD (US); M. Imran Hayee, Columbia, MD (US); William Shieh, Clarksville, MD (US)

Correspondence Address: HARRITY & SNYDER, LLP, 11240 WAPLES MILL ROAD, SUITE 300, FAIRFAX, VA, 22030, US

(21) Appl. No.: 10/036,395

(22) Filed: Jan. 7, 2002

(51) Int. Cl. H04B 10/08; H04B 10/12

(52) U.S. Cl. 398/26

(57) ABSTRACT

An optical transmission system (200) includes a set of spans (220-245), an optical transmitter (205) and a monitor unit (280). Each span of the set of spans includes a link and at least one repeater (215). The optical transmitter (205) transmits optical signals over the set of spans (220-245) according to a first launch power profile. The monitor unit (280) determines power-related parameters over a subset (220-230) of the set of spans. The optical transmitter further transmits optical signals according to a second launch power profile based on the determined power-related parameters.

### FIELD OF THE INVENTION

The present invention relates generally to optical transmission systems and, more particularly, to systems and methods for pre-emphasizing optical transmission system launch power based on a measured subsystem signal-to-noise-ratio (SNR).

### BACKGROUND OF THE INVENTION

Long haul and ultra long haul optical communication systems typically consist of optical terminals interconnected via multiple system spans, with each span including a repeater and an optical link. In such systems, optical signals of different wavelengths are wavelength division multiplexed in the terminal for transmission over the system spans. The repeaters of each span amplify the multiplexed optical signals as the signals traverse the spans of the system

Various types of optical amplification schemes can be used such as, for example, schemes employing erbium-doped fiber amplifiers (EDFAs). EDFAs employ a length of erbium-doped fiber in conjunction with a pump laser that injects a pumping signal having a wavelength of, for example, approximately 1480 nm. This pumping signal interacts with the f-shell of the erbium atoms to stimulate energy emissions that amplify an optical signal having a wavelength of about 1550 nm. One drawback of EDFA amplification techniques is the relatively narrow bandwidth within which amplification occurs, i.e., the so-called erbium spectrum. Future generation systems will likely require wider bandwidths than that available from EDFA amplification in order to increase the number of channels (wavelengths) available on each fiber, thereby increasing system capacity.

Raman amplification is one amplification scheme that can provide a broad and relatively fiat gain profile over a wider wavelength range than that which has conventionally been used in optical communication systems employing EDFA amplification techniques. Raman amplifiers employ a phenomenon known as “stimulated Raman scattering” to amplify the transmitted optical signal. In stimulated Raman scattering, radiation from a pump radiation source interacts with a gain medium through which the optical transmission signal passes to transfer power to that optical transmission signal. One of the benefits of Raman amplification is that the gain medium can be the optical fiber itself, i.e., no specially doped fiber is required as in EDFA techniques. For example, Raman amplification can be performed by coupling a pump laser, which generates a light beam having a predetermined wavelength, at points along the optical fiber. Vibration energy generated by the pump laser beam's interaction with the gain medium is transferred to the transmitted optical signal in a particular wavelength range. This wavelength range establishes the gain profile of the pump laser, the amplitude of which varies as a function of wavelength and which gain profile is centered at a wavelength about 100 nm higher than the wavelength of the pump laser light.

However, the typical gain profile of 20-30 nm for a single wavelength pump laser is too narrow to support the wide bandwidths of, e.g., 100 nm or more, that are desired for next generation optical communication systems. To broaden and flatten the gain profile, Raman amplifiers can use multiple pump lasers for generating pump laser wavelengths over a broad wavelength range. The individual gain profiles attributable to each pump laser sum to provide a combined gain profile that can be used to amplify a transmitted optical signal over a much wider bandwidth.

In conventional optical transmission systems, launch power profiles are used to set the power levels of particular transmitted wavelengths. As shown in plot 100 of FIG. 1, a launch power profile (P_{IN}) may typically consist of a linear power level as a function of wavelength. As shown in plot 105, the system input SNR also may typically consist of a constant level. The output power profile (P_{OUT} 110), measured at an opposite end of the optical system, which includes many intervening links and optical repeaters, typically includes significant power ripple (e.g., peak-to-peak excursion). Further, as shown in plot 115, the SNR existent at the opposite end of the optical system may vary significantly as a function of wavelength. This variance may be due to a number of system factors, such as, for example, the wavelength dependence of amplitude spontaneous emission (ASE) accumulation. This variance may substantially limit the dynamic range available at certain wavelengths (or channels) and, thus, may limit the number of usable system channels. The deviation of the system output SNR from a constant level, therefore, may substantially degrade optical transmission system performance by limiting the number of usable channels.

One technique that compensates for this variance is known as “pre-emphasis.” Pre-emphasis involves adjusting the launch power of each optical signal, e.g., using an attenuator, based upon the expected contribution of the measured effects on each wavelength channel's gain (or analogously its signal-to-noise ration (SNR)). An example of this technique is described in U.S. Pat. No. 6,271,945, the disclosure of which is incorporated herein by reference. Therein, a SNR monitor in the receiving station is used to measure the SNR on individual signal channels as they are received. This information is then sent back to the transmitting station to a controller which controls the power levels to obtain substantially equal SNRs as received by the receiving station.

However, as will be described below in more detail, Applicants have discovered that this technique for performing pre-emphasis is sub-optimal for, at least, some optical communication systems. Therefore, there exists a need for systems and methods for optimizing system SNR to maximize available dynamic range and the number of usable channels.

### SUMMARY OF THE INVENTION

Systems and methods consistent with the present invention address this need and other through the measurement of SNR over a subset of spans of the system spans, and use of the resulting SNR measurement profile as a basis for pre-emphasizing the system launch power. Pre-emphasis of the system launch power may correspond to the inverse of the measured SNR and may produce a substantially constant SNR over the subset of spans at the wavelengths encompassing the launch power profile. Pre-emphasis, consistent with the present invention, increases signal power where ASE accumulation is greatest and also produces an increase in system gain by increasing the lowest channel gain relative to the highest gain channels, thus, avoiding cross-gain saturation. Adjustment of the system launch power profile to produce a substantially constant SNR profile over a subset of system spans increases the dynamic range of poorly performing channels and, therefore, increases the number of channels encompassing the launch power profile that are usable.

In accordance with the purpose of the invention as embodied and broadly described herein, a method of pre-emphasizing an optical system launch power profile includes measuring a signal-to-noise ratio (SNR) over m spans of an n span optical system, wherein m<n; and pre-emphasizing the launch power profile based on a function of the measured SNR.

In another implementation consistent with the present invention, a method of transmitting signals in an optical system comprising a set of spans, the method includes transmitting optical signals according to a first launch power profile; determining power-related parameters over a subset of the set of spans; and transmitting optical signals according to a second launch power profile based on the determined power-related parameters.

In a further implementation consistent with the present invention, a method of optimizing optical system signal-to-noise ratio (SNR) includes measuring SNR over m spans of a n span optical system, wherein m<n; and adjusting a system launch power profile to optimize the SNR measured over the m spans.

### BRIEF DESCRIPTION OF THE DRAWINGS

The accompanying drawings, which are incorporated in and constitute a part of this specification, illustrate embodiments of the invention and, together with the description, explain the invention. In the drawings,

FIG. 1 illustrates conventional optical transmission system launch power profile and SNR;

FIG. 2 illustrates an exemplary system in which systems and methods consistent with the present invention may be implemented;

FIG. 3 illustrates exemplary land terminals and the system underwater portion of FIG. 2 consistent with the present invention;

FIG. 4 illustrates an exemplary terminal consistent with the present invention;

FIG. 5 is a flowchart that illustrates an exemplary process, consistent with the present invention, for pre-emphasizing a launch power profile using measured SNR;

FIG. 6 illustrates an optical transmission system launch power profile and SNR consistent with the present invention; and

FIGS. 7-9 shows simulation data for an optical transmission system with launch power pre-emphasized consistent with the present invention.

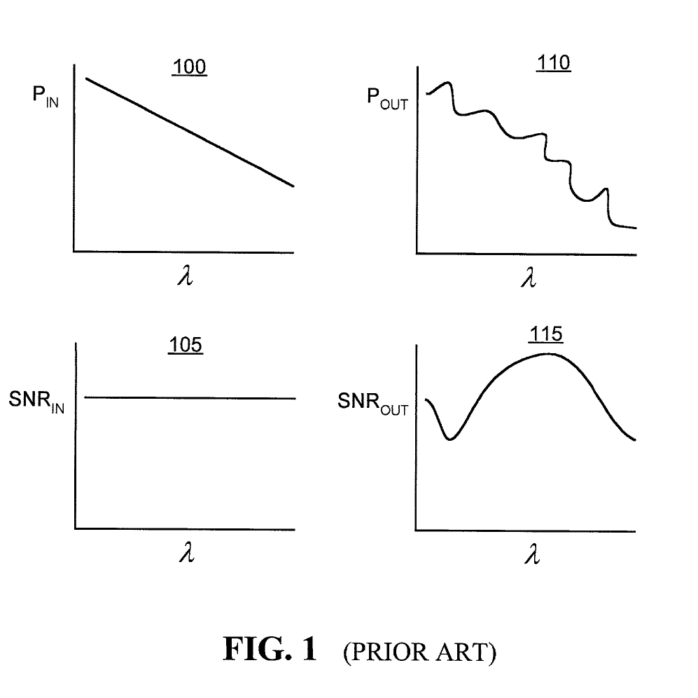

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims.

Systems and methods consistent with the present invention provide mechanisms for optimizing the SNR over a subset of spans of an optical transmission system Through the measurement of SNR over a subset of spans of the system spans, system and methods consistent with the present invention may produce a substantially constant SNR over the subset of spans by pre-emphasizing the system launch power profile based on the measured SNR. Adjustment of the system launch power profile to produce a substantially constant SNR profile over a subset of system spans increases the SNR of poorly performing channels and, therefore, increases the number of channels encompassing the launch power profile that are usable.

### Exemplary System

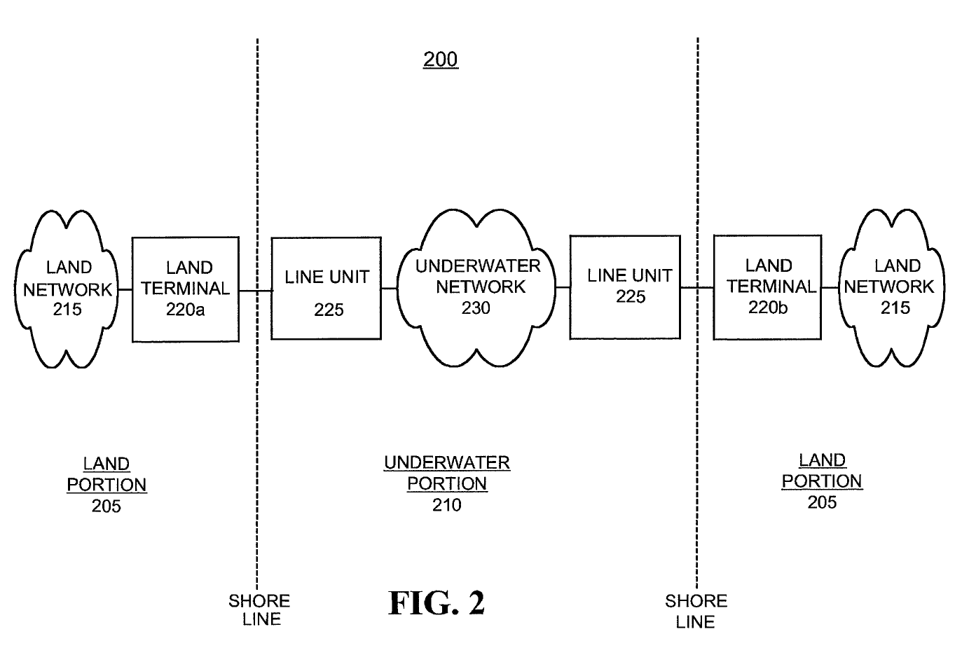

FIG. 2 illustrates an exemplary system 200 in which systems and methods consistent with the present invention may be implemented. System 200 may include two land communication portions 205 that are interconnected via an underwater communication portion 210. The land portions 205 may include land networks 215 and land terminals 220. The underwater portion 210 may include line units 225 (sometimes referred to as “repeaters”) and an underwater network 230. Two land networks 215, land terminals 220a and 220b, and line units 225 are illustrated for simplicity. System 200 may include more or fewer devices and networks than are illustrated in FIG. 2.

Land network 215 may include one or more networks of any type, including a Public Land Mobile Network (PLMN), Public Switched Telephone Network (PSTN), local area network (LAN), metropolitan area network (MAN), wide area network (WAN), Internet, or Intranet. The one or more PLMNs may further include packet-switched sub-networks, such as, for example, General Packet Radio Service (GPRS), Cellular Digital Packet Data (CDPD), and Mobile IP sub-networks. Land terminals 120 include devices that convert signals received from the land network 215 into optical signals for transmission to the line unit 225, and vice versa. The land terminals 220 may connect to the land network 215 via wired, wireless, or optical connections. In an implementation consistent with the present invention, the land terminals 220 connect to the line units 225 via an optical connection.

The land terminals 220 may include, for example, long reach transmitters/receivers that convert signals into an optical format for long haul transmission and convert underwater optical signals back into a format for transmission to the land network 215. The land terminals 220 may also include wave division multiplexers and optical conditioning units that multiplex and amplify optical signals prior to transmitting these signals to line units 225, and line current equipment that provides power to the line units 225 and underwater network 230.

The underwater network 230 may include groups of line units and/or other devices capable of amplifying and routing optical signals in an underwater environment. The line units 225 include devices capable of receiving optical signals and transmitting these signals to other line units 225 via the underwater network 230. The line units 225 may include wave division multiplexers and optical conditioning units that multiplex and amplify received optical signals prior to re-transmitting these signals via underwater network 230.

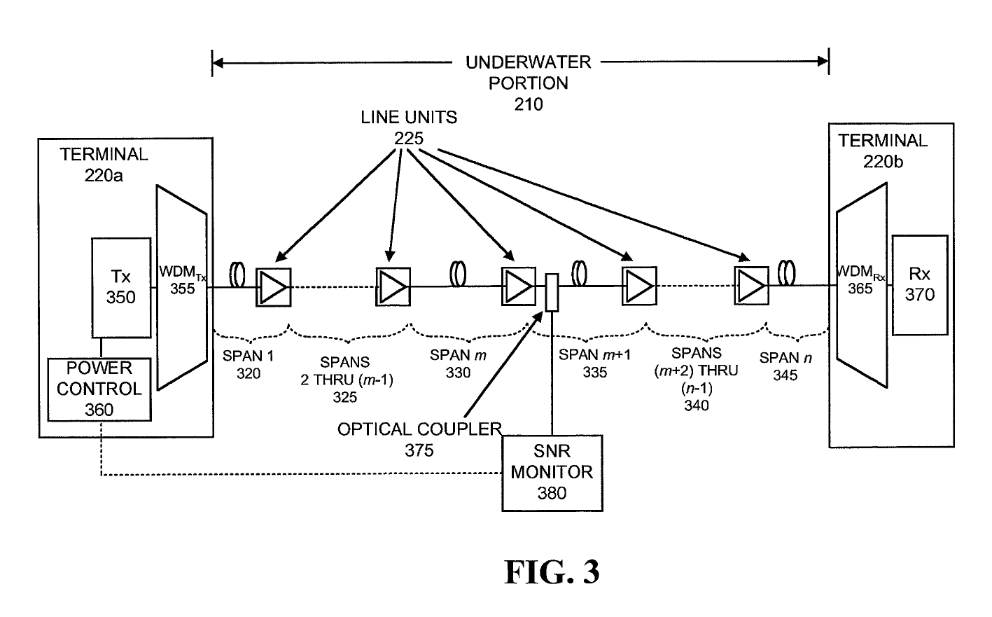

FIG. 3 illustrates terminals 220a and 220b, and exemplary spans of underwater portion 210, of system 200. Terminals 220a and 220b can be interconnected via a system of n spans (e.g., spans 1 320, 2 through (m−1) 325, span m 330, span m+1 335, spans (m+2) through (n−1) 340, span n 345) of links and line units 225, with each span including a single link and a single line unit. Each link may include an optical fiber that can transmit wavelength division multiplexed optical signals between line units 225. The optical fiber(s) in each link may have the same or different dispersion maps. The underwater portion 210 may include more or fewer devices than are illustrated in FIG. 3.

Terminal 220a may include an optical transmitter (Tx) 350, a wavelength division multiplexer (WDM_{Tx}) 355, and a power control unit 360. Tx 350 may include laser diodes for transmitting optical signals at specified wavelengths (λ₁-λ_{N}). Tx 350 may also include optical conditioning units (not shown), such as attenuators and/or filters, for controlling the optical output power of Tx 350. WDMTX 355 may include conventional components for multiplexing the various wavelength optical signals from Tx 350 into wavelength multiplexed optical signals for transmission via the n spans of system 200. Power control unit 360 may include circuitry for controlling the output optical power of each laser diode of Tx 350.

Terminal 220a may include wavelength division multiplexer (WDM_{Rx}) 365 and optical receiver (Rx) 370. WDM_{Rx} 365 may demultiplex the wavelength division multiplexed signals received from the spans of system 200. Rx 370 may receive the demultiplexed optical signals and convert the optical signals into electrical signals for transmission via land network 215.

System 200 may further include an optical coupler 375 and a SNR monitor 380. Optical coupler 375 couples with a link after the mth span 330 from terminal 220a. Optical coupler 375 may, for example, couple with a link after any of the 4^{th}-8^{th} spans of system 200. As a specific example, optical coupler 375 may couple with a link after the 5^{th} span. Optical coupler 375 couples optical signals carried by the set of spans to SNR monitor 380. SNR monitor 380 may measure the signal-to-noise ratio of the coupled signals and, in some embodiments, may provide an indication of the measurement to power control unit 360. Power control unit 360 may, in turn, control the launch power profile of Tx 350 according to the SNR indication received from SNR monitor 380. In other embodiments, the SNR measured by SNR monitor 380 may be used to adjust the launch power profile of Tx 350 prior to deployment of the m spans in underwater portion 210 of system 200.

### Exemplary Terminal

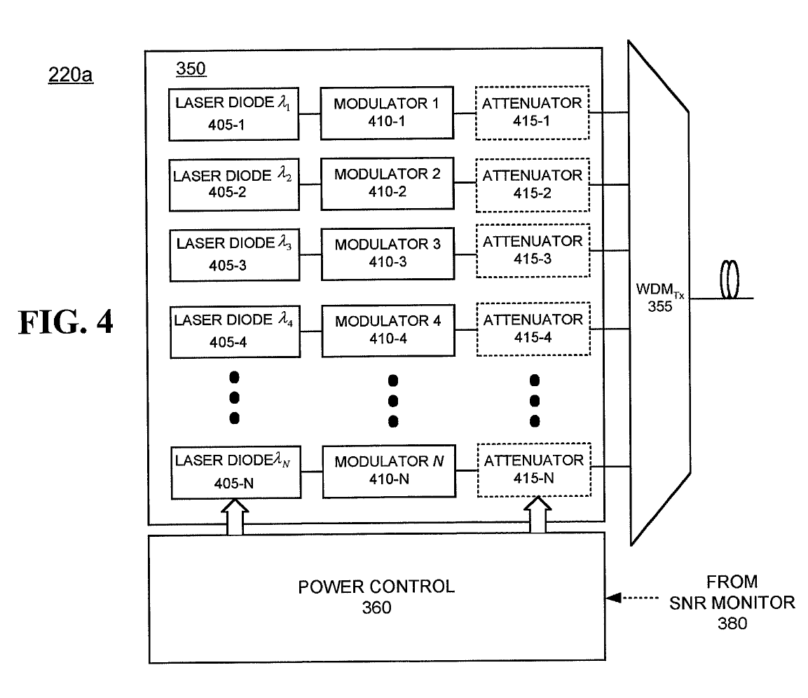

FIG. 4 illustrates a block diagram of exemplary components of Tx 350 of terminal 220a consistent with the present invention. Tx 350 may include N laser diodes (405-1 through 405-N), N modulators (410-1 through 410-N) and N optional attenuators (415-1 through 415-N). Each of the N laser diodes may produce an optical signal at a specified wavelength (λ) and may include circuitry for biasing the laser diode to produce a desired output power. The N modulators may modulate the output of each associated laser diode by information signals that are to be transmitted over system 200. The N optional attenuators may include optical attenuation devices that may be used to adaptively attenuate the optical signals. This adaptive attenuation may be performed according to commands received from power control unit 360. Alternatively, the N optional attenuators may include optical filters (not shown) that may adaptively filter the optical signals according to commands received from power control unit 360. The N attenuators may supply the attenuated signals to WDMTX 355 for wavelength division multiplexing onto an output link.

### Exemplary Launch Power SNR Pre-Emphasis Process

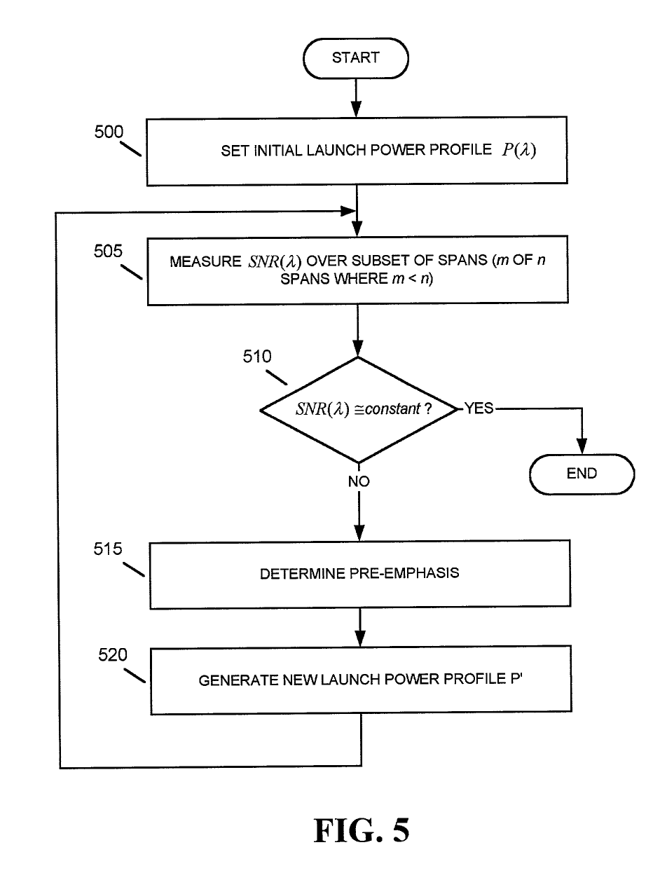

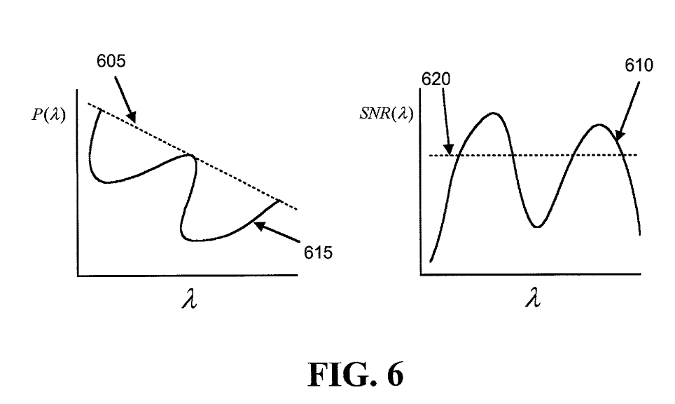

FIG. 5 is a flowchart that illustrates an exemplary process, consistent with the present invention, for pre-emphasizing a terminal launch power profile using measured SNR. The process may begin by setting an initial launch power profile P(λ) (see curve 605, FIG. 6) [act 500]. Power control unit 360 may set power levels of each laser diode (405-1 through 405-N) according to the initial launch power profile by appropriately biasing each laser diode, or by controlling the adaptive attenuators (415-1 through 415-N). The SNR(λ)(see curve 610, FIG. 6) may then be measured over a subset of spans, such as m spans of the n spans of system 200, where m<n [act 505]. For example, SNR monitor 380 may, via optical coupler 375, measure the SNR at span m 330 of system 200.

A determination may then be made of whether the measured SNR(λ) is approximately equal to a constant value across wavelengths [act 510]. SNR monitor 380 may, for example, analyze the measured SNR at wavelengths spanning the launch power profile to determine if the measured SNR across each wavelength is approximately constant. If SNR(λ) is not approximately constant, a pre-emphasis value is determined [act 515], e.g., Pre-emphasis_{dB}(λ)=−[SNR_{dB}(λ)−min(SNR_{dB}(λ))]. This exemplary pre-emphasis value represents an inverse of the measured SNR(λ) normalized to the worst case channel, however those skilled in the art will appreciate that other pre-emphasis values and calculations can be used to implement the present invention. A pre-emphasis (see curve 615, FIG. 6) of the launch power profile P(λ) may then be provided [act 520] by adding the pre-emphasis value to the current launch power for each channel, so that P′_{launchdB}(λ)=P_{launchdB}(λ)+Pre-Emphasis_{dB}(λ). The pre-emphasis may be provided by power control unit 360 via adjustment of the bias current to each laser diode, or by the adaptive control of the attenuators associated with each laser diode. In some embodiments, manual adjustments of power control unit 360 may be performed based on SNR measured by SNR monitor 380 prior to deployment of the spans of system 200 in the underwater portion 210. Acts 505-520 may be selectively repeated until the measured SNR(λ) is approximately constant (see curve 620, FIG. 6).

### System Performance

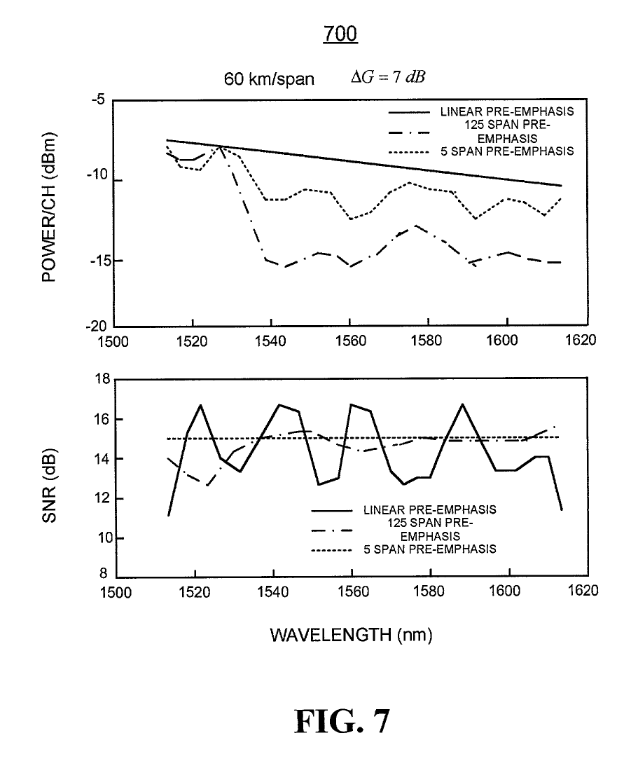

FIG. 7 illustrates simulated performance plots 700 of a 60 km/span 125 span optical transmission system employing subsystem pre-emphasis consistent with the present invention. In this particular example, the system includes gain excursion control (e.g., by way of gain shape filters placed in every Nth repeater) has moderately limited gain excursion (ΔG) to 7 dBpp. As is evident from FIG. 7, subsystem (e.g., 5 span) pre-emphasis in systems having moderate gain excursion control results in substantially improved performance as compared to linear or full system pre-emphasis. Linear pre-emphasis provides a minimum SNR (SNRₘᵢₙ) equal to 11.5 dB, a maximum variation in SNR (δSNR) equal to 5.1 dB, and a maximum variation in launch power (ΔP) equal to 4.3 dB. Full system pre-emphasis, in which SNR is measured after the full set of spans in the system (e.g., 125 spans), provides SNRₘᵢₙ equal to 13.4 dB, δSNR equal to 1.9 dB, and a ΔP equal to 8.7 dB. Subsystem pre-emphasis provides SNRₘᵢₙ equal to 14.6 dB, δSNR equal to 0.05 dB, and a ΔP equal to 5.4 dB. Subsystem pre-emphasis, thus, provides a higher SNR as compared to linear pre-emphasis and full system pre-emphasis, with a nearly 5 dB and 2 db improvement, respectively, in maximum SNR variation.

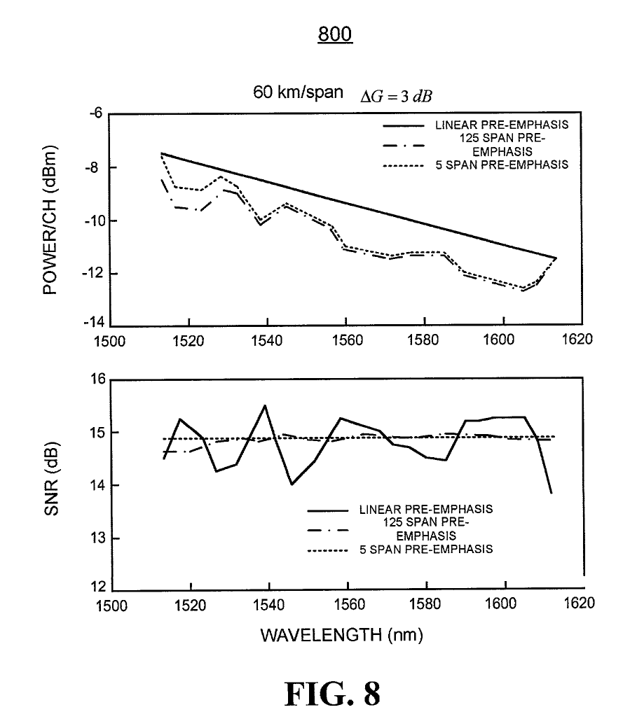

FIG. 8 illustrates additional simulated performance plots 800 of a 60 km/span 125 span optical transmission system employing subsystem pre-emphasis consistent with the present invention. In this example, the system employs good gain excursion control, i.e., gain excursion (ΔG) is limited to 3 dBpp. As is evident from FIG. 8, subsystem (e.g., 5 span) pre-emphasis employed in optical communication systems with good gain excursion control (e.g., ΔG=3 dBpp) results in improved performance as compared to linear or full system pre-emphasis, though not as significant as subsystem pre-emphasis employed in systems having only moderate gain excursion control (see FIG. 7 above). Linear pre-emphasis provides a minimum SNR (SNRₘᵢₙ) equal to 13.8 dB, a maximum variation in SNR (δSNR) equal to 1.7 dB, and a maximum variation in launch power (ΔP) equal to 4.3 dB. Full system pre-emphasis, in which SNR is measured after the full set of spans in the system (e.g., 125 spans), provides SNRₘᵢₙ equal to 14.7 dB, δSNR equal to 0.22 dB, and a AP equal to 4.7 dB. Sub-system pre-emphasis provides SNRₘᵢₙ equal to 14.8 dB, δSNR equal to 0.05 dB, and a ΔP equal to 5.2 dB

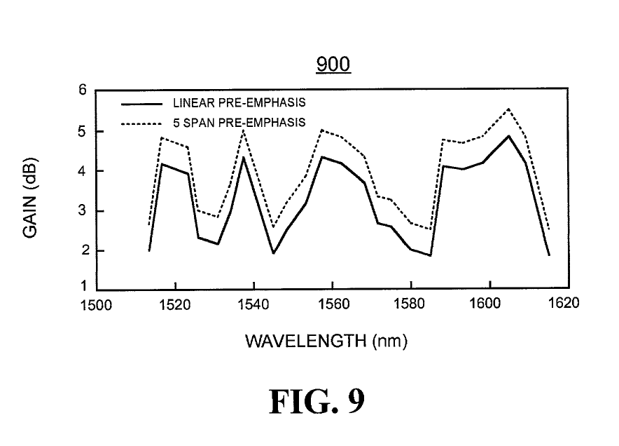

Even with the smaller SNR improvements that may be achieved with subsystem pre-emphasis in systems employing good gain excursion control, subsystem pre-emphasis may significantly increase span set gain (i.e., Pₒᵤₜ−Pᵢₙ[dB]). As shown in FIG. 9, a simulated performance plot 900 of an optical transmission system employing 5 span subsystem pre-emphasis, consistent with the present invention, exhibits an approximate span set gain increase of 0.8 dB as compared to conventional linear pre-emphasis. Subsystem pre-emphasis consistent with the present invention, thus, provides improved SNR along with higher span set gain. Increased span set gain serves to reduce the effect of channel gain saturation by higher performance channels that typically results in neighboring low-gain channels exhibiting low power.

### Conclusion

Systems and methods consistent with the present invention provide mechanisms that permit that optimization of SNR over m spans of an n span optical transmission system, where m<n. System and methods consistent with the present invention measure SNR over m spans of the n system spans and use the resulting SNR measurement profile as a basis for pre-emphasizing the system launch power. Pre-emphasis of the system launch power may be proportional to the inverse of the measured SNR and may produce a substantially constant SNR at the wavelengths encompassing the launch power profile. Adjustment of the system launch power profile to produce a substantially constant SNR profile over m spans of n system spans increases the dynamic range of poorly performing channels and, therefore, increases the number of channels encompassing the launch power profile that are usable.

The foregoing description of exemplary embodiments of the present invention provides illustration and description, but is not intended to be exhaustive or to limit the invention to the precise form disclosed. Modifications and variations are possible in light of the above teachings or may be acquired from practice of the invention. While the above description focused on an underwater environment, implementations consistent with the present invention are not so limited. For example, the systems and methods disclosed herein could alternatively be implemented in ground-based, space or aerospace environments.

While series of acts have been described with regard to FIG. 5, the order of the acts may be altered in other implementations. Moreover, non-dependent acts may be performed in parallel. No element, act, or instruction used in the description of the present application should be construed as critical or essential to the invention unless explicitly described as such. Also, as used herein, the article “a” is intended to include one or more items. Where only one item is intended, the term “one” or similar language is used. The scope of the invention is defined by the following claims and their equivalents.

What is claimed is:

1. A method of pre-emphasizing an optical system launch power profile, comprising:
measuring a signal-to-noise ratio (SNR) over m spans of an n span optical system, wherein m<n; and
pre-emphasizing the launch power profile based on a function of the measured SNR.

2. The method of claim 1, wherein each span of the n spans comprises a link and at least one repeater.

3. The method of claim 1, wherein the function comprises an inverse of the SNR.

4. The method of claim 1, wherein the SNR comprises a SNR profile.

5. The method of claim 1, further comprising:
optimizing the pre-emphasis of the launch power profile such that a profile of the SNR comprises a substantially constant value.

6. The method of claim 1, further comprising:
selectively repeating the launch power profile pre-emphasis to optimize the measured SNR.

7. A system for pre-emphasizing an optical system launch power profile, comprising:
means for measuring a signal-to-noise ratio (SNR) over m spans of an n span optical system, wherein m<n; and
means for pre-emphasizing the launch power profile based on a function of the measured SNR.

8. A method of transmitting signals in an optical system comprising a set of spans, the method comprising:
transmitting optical signals according to a first launch power profile;
determining power-related parameters over a subset of the set of spans; and
transmitting optical signals according to a second launch power profile based on the determined power-related parameters.

9. The method of claim 8, wherein the power-related parameters comprise a signal-to-noise power ratio profile.

10. The method of claim 8, further comprising:
comparing the power-related parameters to a set of desired parameters.

11. The method of claim 10, further comprising:
adjusting the second launch power profile until the determined power-related parameters substantially equal the set of desired parameters.

12. The method of claim 11, wherein the set of desired parameters comprises a signal-to-noise ratio (SNR) profile.

13. The method of claim 12, wherein the SNR profile comprises a substantially constant SNR value.

14. An optical transmission system, comprising:
a set of spans, wherein each span of the set of spans comprises a link and at least one repeater;
an optical transmitter configured to transmit optical signals over the set of spans according to a first launch power profile; and
a monitor unit configured to determine power-related parameters over a subset of the set of spans,
the optical transmitter further configured to transmit optical signals according to a second launch power profile based on the determined power-related parameters.

15. The system of claim 14, wherein the power-related parameters comprise a signal-to-noise power ratio profile.

16. The system of claim 14, the optical transmitter further configured to:
compare the power-related parameters to a set of desired parameters.

17. The system of claim 16, the optical transmitter further configured to:
adjust the second launch power profile until the determined power-related parameters substantially equal the set of desired parameters.

18. The system of claim 17, wherein the set of desired parameters comprises a signal-to-noise ratio (SNR) profile.

19. The system of claim 18, wherein the SNR profile comprises a substantially constant SNR value.

20. A method of optimizing optical system signal-to-noise ratio (SNR), comprising:
measuring SNR over m spans of a n span optical system, wherein m<n; and
adjusting a system launch power profile to optimize the SNR measured over the m spans.

21. The method of claim 20, wherein each span of the n spans comprises a link and at least one repeater.

22. The method of claim 20, wherein the SNR comprises a SNR profile.

23. The method of claim 22, further comprising:
adjusting the system launch power profile such that the SNR profile comprises a substantially constant value.

24. The method of claim 20, further comprising:
selectively repeating the system launch power profile adjustment to optimize the measured SNR.

25. An system for optimizing optical system signal-to-noise ratio (SNR), comprising:
a monitoring unit configured to measure SNR over m spans of an n span optical system, wherein m<n; and
an optical transmitter configured to adjust a system launch power profile to optimize the SNR measured over the m spans.

26. The system of claim 25, wherein each span of the n spans comprises a link and at least one repeater.

27. The system of claim 25, wherein the SNR comprises a SNR profile.

28. The system of claim 27, further comprising:
adjusting the system launch power profile such that the SNR profile comprises a substantially constant value.

29. The system of claim 25, further comprising:
selectively repeating the system launch power profile adjustment to optimize the measured SNR.

30. The method of claim 3, wherein said inverse of the SNR is normalized based on a channel having a lowest SNR performance.
